(19) United States
(12) Patent Application Publication
(10) Pub. No.: US 2004/0196389 A1
(43) Pub. Date: Oct. 7, 2004

(54) Image pickup apparatus and method thereof

(76) Inventor: Yoshiaki Honda, Kanagawa (JP)

Correspondence Address: COWAN LIEBOWITZ & LATMAN P.C, JOHN J TORRENTE, 1133 AVE OF THE AMERICAS, 1133 AVE OF THE AMERICAS, NEW YORK, NY, 10017, US

(21) Appl. No.: 10/770,592

(22) Filed: Feb. 3, 2004

(30) Foreign Application Priority Data
Feb. 4, 2003 (JP) 2003-027145
Feb. 3, 2004 (JP) 2004-026750

(51) Int. Cl. H04N 5/262

(52) U.S. Cl. 348/231.7

(57) ABSTRACT

An image pickup apparatus can change a resolution (or total number of pixels) of RAW data to a resolution (or total number of pixels) set by a user. The image pickup apparatus includes: an image pickup unit for picking up an image; and a reduction unit for reducing a resolution of original image data, which is obtained by digitizing the image picked up by the image pickup unit, to a resolution set by a user before the image data is stored onto a detachable recording medium.

### BACKGROUND OF THE INVENTION

1. Field of the Invention

The present invention relates to an image pickup apparatus such as a digital camera.

2. Related Background Art

An image pickup apparatus such as a digital camera is capable of recording, on a recording medium, in the JPEG format or the RAW format, original image data (also called RAW data) which is obtained by digitizing an image that is picked up by an image pickup element. In the case of the JPEG format, RAW data is subjected to predetermined image processing (an adjustment of white balance and the like) and is compressed by an irreversible compression method such as baseline JPEG (see ISO/IEC 10918-1: 1994 and ISO/IEC 10918-2: 1995, for example) before recorded on a recording medium. On the other hand, in the case of the RAW format, RAW data is compressed by a reversible compression method, without being subjected to the predetermined image processing (an adjustment of white balance and the like), and is recorded on a recording medium. The RAW format is a useful recording format which allows an image to be adjusted for white balance and the like freely after the image is picked up. An example of known documents that disclose inventions related to the RAW format is Japanese Patent Application Laid-Open No. 2001-60876.

Conventionally, an image pickup apparatus writes RAW data in the RAW format on a recording medium at the maximum resolution. This raises a problem when an image pickup element is very large in pixel number, since in that case the data size of RAW data becomes large and RAW data that can be recorded on a recording medium is accordingly reduced.

An image pickup element having a very large pixel number also poses another problem in that it takes long time to process RAW data. Accordingly, a time period from the time of photographing an image till completion of recording RAW data of the image on a recording medium becomes longer, making it difficult to shorten the time interval between one shot and the next shot during continuous photographing.

Future image pickup apparatuses are therefore desired to be capable of recording RAW data with its resolution (or total number of pixels) reduced.

### SUMMARY OF THE INVENTION

An Object of the present invention is to overcome the above-described drawbacks.

Another object of the present invention is to provide an image pickup apparatus which attains to change the resolution (or total number of pixels) of RAW data to the resolution (or total number of pixels) set by a user.

According to an aspect of the present invention, an image pickup apparatus of the present invention includes:

an image pickup unit for picking up an image; and

a reduction unit for reducing a resolution of original image data, which is obtained by digitizing the image picked up by the image pickup unit, to a resolution set by a user before the image data is stored onto a detachable recording medium.

According to an another aspect of the present invention, a method for an image pickup apparatus of the present invention includes:

an image pickup step of pickup an image using an image pickup unit; and

a reduction step of reducing a resolution of original image data, which is obtained by digitizing the image picked up by the image pickup unit, to a resolution set by a user before the image data is stored onto a detachable recording medium.

Still other objects, features and advantages of the present invention will become fully apparent from the following detailed description of the preferred embodiments.

### BRIEF DESCRIPTION OF THE DRAWINGS

FIG. 1 is a block diagram showing main structural components of a digital camera as an example of an image pickup apparatus according to a first embodiment;

FIG. 2 is a flow chart illustrating operation of the digital camera according to the first embodiment;

FIG. 3 is a diagram illustrating a procedure for reducing the resolution of RAW data in each of horizontal and vertical directions to ⅔; and

FIG. 4 is a diagram illustrating a procedure for reducing the resolution of RAW data in each of horizontal and vertical directions to ½.

### DETAILED DESCRIPTION OF THE PREFERRED EMBODIMENTS

Referring to the accompanying drawings, embodiments of the present invention will be described below.

First Embodiment

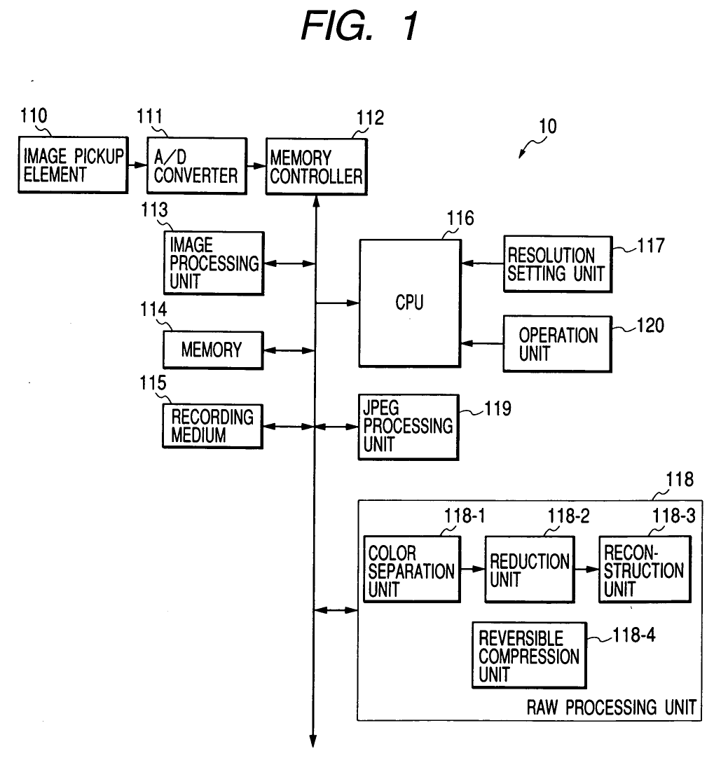

FIG. 1 is a block diagram showing main structural components of a digital camera 10, which is an example of an image pickup apparatus according to the first embodiment.

In FIG. 1, reference numeral 110 denotes an image pickup element (image sensor) such as a CCD sensor or a CMOS sensor. The image pickup element 110 employs R (red), G (green), and B (blue) color filters and Bayer array. Instead of the element 110, an image pickup element in which pixels are arranged differently may be used.

Denoted by 111 is an A/D converter for digitizing an image that is picked up by the image pickup element 110, to thereby create original image data. In the first embodiment, original image data which is outputted from the A/D converter 111 and which has not yet been subjected to adjustment of white balance, contrast, sharpness, deepness of color, hue, etc. is called RAW data.

Denoted by 112 is a memory controller for storing, in a memory 114, RAW data that is outputted from the A/D converter 111.

Reference numeral 113 denotes an image processing unit for performing defect correction processing on RAW data. In the first embodiment, processing for correcting defects of the image pickup element 110, lack of data due to dust settled on the image pickup element 110, and the like is called defect correction processing. The image processing unit 113 also performs predetermined image processing (an adjustment of white balance, contrast, sharpness, deepness of color, hue, etc.) on RAW data when the RAW data is to be recorded in the JPEG format.

The memory 114 has a memory capacity capable of keeping RAW data of a plurality of images.

Denoted by 115 is a recording medium which allows random access and which is detachable from the digital camera 10 (for example, a memory card incorporating a non-volatile semiconductor memory).

116 denotes a CPU (Central Processing Unit) for controlling operation of the digital camera 10.

117 denotes a resolution setting unit for setting the resolution (or total number of pixels) of RAW data to be stored on the recording medium 115. The resolution setting unit 117 can set large, middle, or small RAW. In the first embodiment, the maximum resolution is called large RAW, the resolution obtained by reducing the large RAW resolution in each of horizontal and vertical directions to ⅔ is called middle RAW, and the resolution obtained by reducing the large RAW resolution in each of horizontal and vertical directions to ½ is called small RAW. Large RAW in the first embodiment is the resolution of RAW data that is outputted from the A/D converter 111. The resolution setting unit 117 notifies the CPU 116 of the resolution set by a user.

Denoted by 118 is a RAW processing unit for changing the resolution (or total number of pixels) of RAW data and for compressing RAW data.

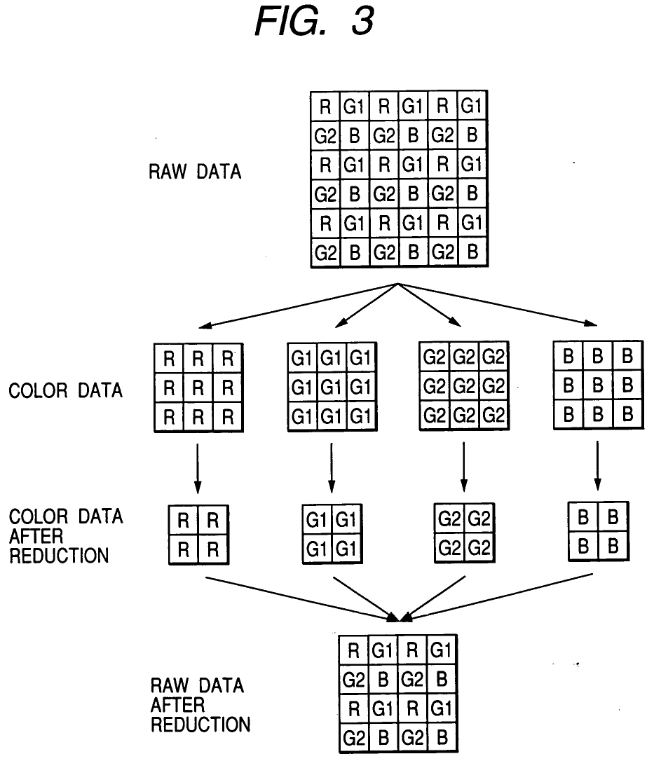

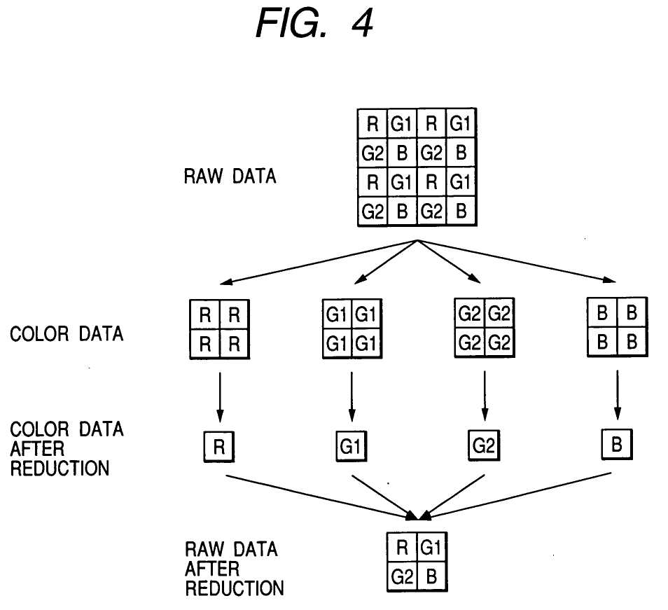

118-1 denotes a color separation unit for separating data of plural colors from RAW data. In the first embodiment, color data separated from RAW data are data of four colors. Data of four colors are composed of red color data (R) for red component, first green color data (G1) for first green component, second green color data (G2) for second green component, and blue color data (B) for blue component. To reduce the resolution of RAW data in each of horizontal and vertical directions to ⅔, red color data (R), first green color data (G1), second green color data (G2), and blue color data (B) are separated from RAW data in such a manner shown in FIG. 3. On the other hand, to reduce the resolution of RAW data in each of horizontal and vertical directions to ½, red color data (R), first green color data (G1), second green color data (G2), and blue color data (B) are separated from RAW data in such a manner shown in FIG. 4.

118-2 denotes a reduction unit for reducing the size of respective color data in each of horizontal and vertical directions to ⅔ or ½ with the use of a digital filter. The reduction unit 118-2 can also use an interpolation method such as the bicubic method or the nearest neighbor method to reduce the size of respective color data in each of horizontal and vertical directions to ⅔ or ½. To reduce the resolution of RAW data in each of horizontal and vertical directions to ⅔, red color data (R), first green color data (G1), second green color data (G2), and blue color data (B) are each reduced in resolution in each of horizontal and vertical directions to ⅔ in the manner shown in FIG. 3. On the other hand, to reduce the resolution of RAW data in each of horizontal and vertical directions to ½, red color data (R), first green color data (G1), second green color data (G2), and blue color data (B) are each reduced in resolution in each of horizontal and vertical directions to ½ in the manner shown in FIG. 4.

118-3 denotes a reconstruction unit for reconstructing RAW data of middle or small RAW from data of plural colors that are outputted from the reduction unit 118-2. In the first embodiment, RAW data is reconstructed from data of plural colors in the manner shown in FIG. 4. When the resolution of RAW data is reduced in each of horizontal and vertical directions to ⅔, the RAW data is reconstructed from red color data (R), first green color data (G1), second green color data (G2), and blue color data (B) in the manner shown in FIG. 3. On the other hand, when the resolution of RAW data is reduced in each of horizontal and vertical directions to ½, the RAW data is reconstructed from red color data (R), first green color data (G1), second green color data (G2), and blue color data (B) in the manner shown in FIG. 4.

118-4 denotes a reversible compression unit for compressing PAW data of large, middle, or small RAW in accordance with a predetermined reversible compression method (e.g., an original reversible compression method or a reversible compression method standardized by JPEG 2000 or by TIFF).

Denoted by 119 is a JPEG processing unit for compressing digital image data that is outputted from the image processing unit 113, in accordance with baseline JPEG.

Denoted by 120 is an operation unit for inputting a photographing instruction, setting an image recording format, setting the resolution of JPEG data, etc.

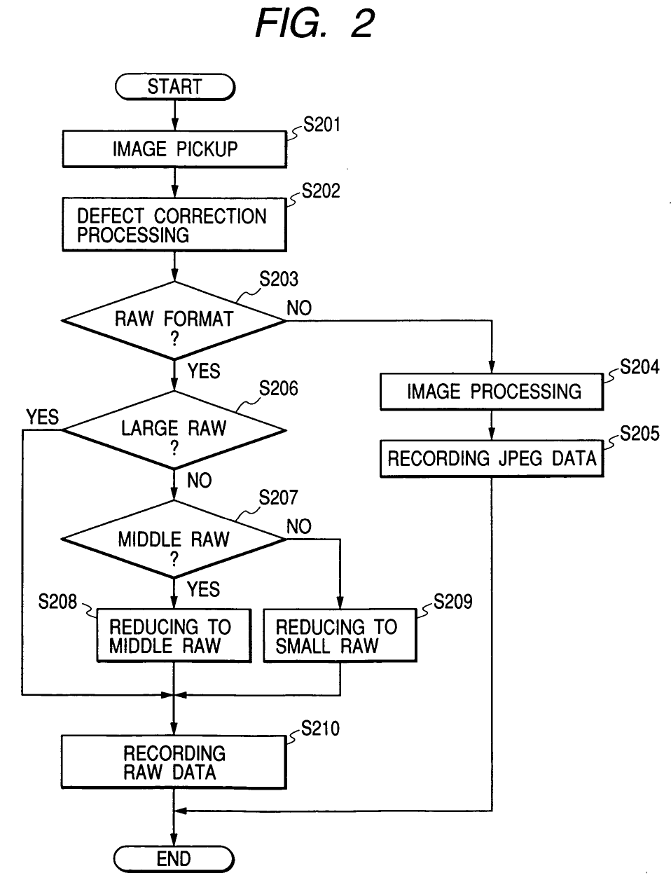

FIG. 2 is a flow chart illustrating operation of the digital camera 10 according to the first embodiment. The processing shown in the flow chart of FIG. 2 may be controlled using a program that can be executed by the CPU 116.

Step S201: Upon receiving a photographing instruction, the image pickup element 110 picks up an image. The image picked up by the image pickup element 110 is digitized by the A/D converter 111 to create original image data (namely, RAW data). The RAW data outputted from the A/D converter 111 is stored in the memory 114 through the memory controller 112. The RAW data stored in the memory 114 is of large RAW since the resolution of RAW data that is outputted from the A/D converter 111 is large RAW.

Step S202: The image processing unit 113 performs defect correction processing on the RAW data stored in the memory 114.

Step S203: The CPU 116 decides whether the image recording format set by a user before photographing is RAW format or not. When it is judged that the set image recording format is RAW format, the process proceeds to Step S206. When it is judged that the set image recording format is not RAW format, the process proceeds to Step S204.

Step S204: When the image recording format set by the user is the JPEG format, the image processing unit 113 reduces the resolution of the RAW data stored in the memory 114 to the one set by the user, and then performs predetermined image processing (an adjustment of white balance, contrast, sharpness, deepness of color, hue, etc.) on the reduced RAW data.

Step S205: The JPEG processing unit 119 compresses the RAW data that has been processed in the image processing unit 113, in accordance with the baseline JPEG. In the first embodiment, RAW data compressed in accordance with the baseline JPEG is called JPEG data. The JPEG data created in the JPEG processing unit 119 is stored in the memory 114. The CPU 116 creates a JPEG file that contains the JPEG data stored in the memory 114, and stores the created JPEG file in the memory 114. The JPEG file also contains such data as information about photographing conditions, information about development conditions that are set in the digital camera 10, and information about the JPEG data (resolution and the like). The RAW file stored in the memory 114 is recorded on the recording medium 115 by the CPU 116.

Step S206: The CPU 116 decides whether the resolution set by the user before photographing is large RAW or not. When it is judged that the set resolution is large RAW, the process proceeds to Step S210. When it is judged that the set resolution is not large RAW, the process proceeds to Step S207.

Step S207: The CPU 116 decides whether the resolution set by the user before photographing is taken is middle RAW or not. When it is judged that the set resolution is middle RAW, the process proceeds to Step S208. When it is judged that the set resolution is not middle RAW, the process proceeds to Step S209.

Step S208: When the resolution set by the user is middle RAW, the RAW processing unit 118 reads RAW data of large RAW out of the memory 114 and inputs the RAW data read out to the color separation unit 118-1. The color separation unit 118-1 separates data of plural colors from the RAW data of large RAW (see the RAW data and color data in FIG. 4). The data of plural colors outputted from the color separation unit 118-1 are inputted to the reduction unit 118-2. The reduction unit 118-2 reduces the resolution of the respective color data in each of horizontal and vertical directions to ⅔ (see the color data and color data after reduction in FIG. 3). The data of plural colors outputted from the reduction unit 118-2 are inputted to the reconstruction unit 118-3. The reconstruction unit 118-3 reconstructs RAW data of middle RAW from the inputted data of plural colors (see the color data after reduction and RAW data after reduction in FIG. 3). At this point, the RAW data of middle RAW is reconstructed so as to have the same structure as the RAW data of large RAW. This means that RAW data of middle RAW is reconstructed so as to have the Bayer array if RAW data of large RAW has the Bayer array. As a result, the RAW data of middle RAW obtains resolution (or total number of pixels) reduced to 4/9 of the resolution (or total number of pixels) of the RAW data of large RAW. The reversible compression unit 118-4 compresses the RAW data of middle RAW in accordance with a predetermined reversible compression method, and stores the compressed RAW data in the memory 114.

Step S209: When the resolution set by the user is small RAW, the RAW processing unit 118 reads RAW data of large RAW out of the memory 114 and inputs the RAW data read out to the color separation unit 118-1. The color separation unit 118-1 separates data of plural colors from the RAW data of large RAW (see the RAW data and color data in FIG. 4). The data of plural colors outputted from the color separation unit 118-1 are inputted to the reduction unit 118-2. The reduction unit 118-2 reduces the resolution of the respective color data in each of horizontal and vertical directions to ½ (see the color data and color data after reduction in FIG. 4). The data of plural colors outputted from the reduction unit 118-2 are inputted to the reconstruction unit 118-3. The reconstruction unit 118-3 reconstructs RAW data of small RAW from the inputted data of plural colors (see the color data after reduction and RAW data after reduction in FIG. 4). At this point, the RAW data of small RAW is reconstructed so as to have the same structure as the RAW data of large RAW. This means that RAW data of small RAW is reconstructed so as to have the Bayer array if RAW data of large RAW has the Bayer array. As a result, the RAW data of small RAW obtains resolution (or total number of pixels) reduce to ¼ of the resolution (or total number of pixels) of the RAW data of large RAW. The reversible compression unit 118-4 compresses the RAW data of small RAW in accordance with a predetermined reversible compression method, and stores the compressed RAW data in the memory 114.

Step S210: The CPU 116 creates a RAW file that contains the RAW data of large, middle, and small RAW stored in the memory 114, and stores the created RAW file in the memory 114. The RAW file also contains such data as information about photographing conditions, information about development conditions that are set in the digital camera 10, and information about the RAW data (resolution and the like). The RAW file stored in the memory 114 is recorded on the recording medium 115 by the CPU 116.

As has been described, the digital camera 10 according to the first embodiment of the present invention is capable of recording RAW data of a picked-up image on the recording medium 115 at a resolution 4/9 or ¼ of its maximum resolution (or total number of pixels). Therefore, more RAW data can be recorded in the RAW format on the recording medium 115. The digital camera 10 is also capable of cutting short the time required for development processing of RAW data (an adjustment to make RAW data into displayable image data). In addition, if the resolution is set to middle RAW or small RAW, the time interval between one shot and the next shot can be shortened when taking pictures successively.

In the digital camera 10 according to the first embodiment, the processing for reducing the resolution is performed on the respective color data separately. In this way, processing for the respective color data can be shared and accordingly, the processing for reducing the resolution of RAW data can be simplified.

Second Embodiment

The image pickup apparatus according to the first embodiment is arranged to reduce RAW data of large RAW to one of two resolution levels, but instead may be arranged so as to reduce RAW data of large RAW to a resolution level chosen out of more than two resolution levels. Moreover, the image pickup apparatus according to the first embodiment in which middle RAW is 4/9 of large RAW and small RAW is ¼ of large RAW may be arranged so as to set the resolution differently. It is also possible to arrange the image pickup apparatus such that RAW data of large RAW is reduced in accordance with a reduction ratio inputted by a user.

Third Embodiment

The image pickup apparatus according to each of the first and second embodiments use an image pickup element that employs R (red), G (green), and B (blue) color filters. Alternatively, the image pickup element having Mg (magenta), Cy (cyan), Ye (yellow), and Gr (Green) color filters also may be used. It is also possible for the apparatuses to use image pickup elements that have other sets of color filters.

Fourth Embodiment

The image pickup apparatus according to each of the first to third embodiments is arranged so as to compress RAW data of large, middle, or small RAW in accordance with a predetermined reversible compression method (e.g., an original reversible compression method or a reversible compression method standardized by JPEG 2000 or by TIFF) when the image recording format is the RAW format. Alternatively, the apparatus may not compress RAW data of large, middle, or small RAW.

The image pickup apparatus according to each of the first to third embodiments is arranged so as to compress RAW data in accordance with the baseline JPEG when the image recording format is the JPEG format. However, it is also possible for the apparatus to compress RAW data in accordance with other irreversible compression methods than the baseline JPEG. One of employable irreversible compression methods other than the baseline JPEG is JPEG 2000 (see ISO/IEC 15444-1: 2000).

Fifth Embodiment

The image pickup apparatus according to each of the first to fourth embodiments may be arranged so as to have external apparatus (a printer, a personal computer, and the like) that are loaded in or connected to the image pickup apparatus execute the processing performed by the color separation unit 118-1, the reduction unit 118-2, and the reconstruction unit 118-3.

Sixth Embodiment

The image pickup apparatus according to each of the first to fifth embodiments is arranged so as to omit an adjustment of white balance, contrast, sharpness, deepness of color, hue, etc. when RAW data is recorded in the RAW format. Alternatively, the apparatus may be arranged so as to adjust RAW data in some of the those items.

It is obvious that the functions of the above-described embodiments of the present invention also can be realized by providing a system or an apparatus with a recording medium on which a program code of software for executing the functions of the above embodiments is recorded, so that a computer (or CPU or MPU) of the system or apparatus reads the program code recorded on the recording medium and executes the functions.

In this case, the program code itself read out from the recording medium implements the functions of the above embodiments, meaning that the recording medium that stores the program code constitutes the present invention. Examples of employable recording media for supplying such program codes include floppy (R) disks, hard disks, optical disks, magneto-optical disks, CD-ROMs, CD-Rs, magnetic tapes, non-volatile recording media, and ROMs. Instead of implementing the functions of the above embodiments by executing the program code read out by the computer, an OS or the like running on the computer may handle all or a part of actual processing in accordance with instructions of the program code, so that the functions of the above embodiments are implemented through the actual processing. This case also constitutes the present invention.

Also, the functions of the above-described embodiments may be implemented through processing by a CPU or the like provided in an extension board, which is inserted to the computer, or in an extension unit, which is connected to the computer. In this case, the program code read out from the recording medium is written in a memory provided in the extension board or in the extension unit. Then, the CPU or the like of the extension board or of the extension unit implements an expanded function of the extension board or extension unit to execute all or a part of actual processing in accordance with the next instruction of the program code. Through the actual processing, the functions of the above embodiments are implemented. This case also constitutes the present invention.

Moreover, the functions of the above embodiments also may be implemented by placing an apparatus that has the above-described recording medium on a network, downloading a program that is stored on the recording medium to a predetermined apparatus through the network, and executing the downloaded program.

The above-described preferred embodiments are merely exemplary of the present invention, and are not be construed to limit the scope of the present invention.

The scope of the present invention is defined by the scope of the appended claims, and is not limited to only the specific descriptions in this specification. Furthermore, all modifications and changes belonging to equivalents of the claims are considered to fall within the scope of the present invention.

What is claimed is:

1. An image pickup apparatus comprising:
an image pickup unit for picking up an image; and
a reduction unit for reducing a resolution of original image data, which is obtained by digitizing the image picked up by the image pickup unit, to a resolution set by a user before the image data is stored onto a detachable recording medium.

2. An image pickup apparatus according to claim 1, further comprising an image compression unit for compressing the reduced image data in accordance with a predetermined reversible compression method.

3. An image pickup apparatus according to claim 1, wherein the image pickup unit is an image pickup element having a Bayer array.

4. An image pickup apparatus according to claim 1, wherein the reduction unit reduces the image data on the each color basis.

5. An image pickup apparatus according to claim 1,
wherein the image pickup unit is an image pickup element having a Bayer array, and
wherein the reduction unit reduces the image data on the each color basis.

6. An image pickup apparatus according to claim 5, further comprising an image compression unit for compressing the reduced image data in accordance with a predetermined reversible compression method.

7. A method for an image pickup apparatus, comprising:
an image pickup step of pickup an image using an image pickup unit; and
a reduction step of reducing a resolution of original image data, which is obtained by digitizing the image picked up by the image pickup unit, to a resolution set by a user before the image data is stored onto a detachable recording medium.

8. A method for an image pickup apparatus according to claim 7, further comprising an image compression step of compressing the reduced image data in accordance with a predetermined reversible compression method.

9. A method for an image pickup apparatus according to claim 7, wherein the image pickup unit is an image pickup element having a Bayer array.

10. A method for an image pickup apparatus according to claim 7, wherein the reduction step includes a step of reducing the image data on the each color basis.

11. A method for an image pickup apparatus according to claim 7,
wherein the image pickup unit is an image pickup element having a Bayer array, and
wherein the reduction step includes a step of reducing the image data on the each color basis.

12. A method for an image pickup apparatus according to claim 11, further comprising an image compression step of compressing the reduced image data in accordance with a predetermined reversible compression method.

13. A digital camera, comprising:
an image pickup unit for picking up an image; and
a reduction unit for reducing a resolution of original image data, which is obtained by digitizing the image picked up by the image pickup unit, to a resolution set by a user before the image data is stored onto a detachable recording medium.

14. A digital camera according to claim 13, further comprising an image compression unit for compressing the reduced image data in accordance with a predetermined reversible compression method.

15. A digital camera according to claim 13, wherein the image pickup unit is an image pickup element having a Bayer array.

16. A digital camera according to claim 13, wherein the reduction unit reduces the image data on the each color basis.

17. A digital camera according to claim 13,
wherein the image pickup unit is an image pickup element having a Bayer array, and
wherein the reduction unit reduces the image data on the each color basis.

18. A digital camera according to claim 17, further comprising an image compression unit for compressing the reduced image data in accordance with a predetermined reversible compression method.
